(19) United States
(12) Patent Application Publication
(10) Pub. No.: US 2003/0090117 A1
(43) Pub. Date: May 15, 2003

(54) Modular cabinet and hanging sustem

(76) Inventors: David C. Cormier, Crestview, FL (US); Barbara J. Cormier, Crestview, FL (US)

Correspondence Address: Carnes, Cona & Dixon, Innovation Park, 1673 West Paul Dirac Drive, Tallahassee, FL, 32310-3763, US

(21) Appl. No.: 10/207,679

(22) Filed: Jul. 29, 2002

Related U.S. Application Data
(60) Provisional application No. 60/308,456, filed on Jul. 30, 2001.

(51) Int. Cl. B60P 3/32

(52) U.S. Cl. 296/24.1; 296/190.02

(57) ABSTRACT

A modular cabinet for use in a vehicle having a fold-down bed is disclosed. The cabinet includes a frame having a pair of brackets, wherein a first end of each of the brackets is adapted for clasping an upper edge of the fold-down bed, when in its folded-up position. A second end of each of the brackets is adapted for clasping the lower edge of the fold-down bed. The cabinet also includes a pair of securing straps for wrapping around a side of the fold-down bed opposite from the cabinet frame and each including two ends thereof for coupling to the two ends of each of the brackets. A pair of cam buckles are also included for tightening each of the securing straps around the fold-down bed, thereby securing the cabinet frame to the fold-down bed. The cabinet further includes shelves for storage and netting or curtains to cover the openings and secure the contents thereof. A garment hanging rod may also be integrated with the cabinet or installed separately on the fold-down bed or adjacent cabinets.

### BACKGROUND OF THE INVENTION

1. Field of the Invention

The present invention relates generally to a removeably secured modular cabinet and hanging system and more particularly to a removeably secured modular cabinet and hanging system specifically for use in the cab or sleeping compartment of a tractor trailer truck, boat or camper (hereinafter “vehicle”). The cabinet of this invention will adequately maintain items in an organized storage system, as well as on a hanging rod for the storage of garments and the like by way of hangers in a fixed and wrinkle free environment.

2. Description of the Prior Art

The term tractor as used herein refers to a truck designed primarily to pull a semi-trailer by means of a fifth wheel mounted over the rear axle. The majority of tractors are of a cab-over/conventional design, in which the cab sits over the engine on the chasis. In order to accommodate the sleeping requirements of the truck driver, many tractor trucks are built with a cab that contains a sleeper compartment. The sleeper compartment provides the truck driver with adequate sleeping quarters so as to allow the driver to rest during off hours. The sleeping compartment is also essential for driver teams in which a team of two drivers alternate driving and resting. However, even with the additional space of the sleep compartment, there is often times a lack of storage space, and limited space to hang clothes, which results in a cluttered and unorganized area.

There have been numerous storage systems developed to provide for article storage in cars, pick-up trucks and tractor trailers. For example, U.S. Pat. No. 5,915,777 issued to Gignac, et al, wherein disclosed is a cab compartment storage system for use in a pick-up truck so as to provide for close proximity of article stowage on the rear cab wall. Although this device may be suitable for use in a pick-up truck, it would not provide adequate storage for a truck driver required to be on the road for long hauls due to its small size and small compartments therein. In addition, this device does not provide for a system for hanging garments.

Yet another device is disclosed in U.S. Pat. No. 5,356,061 issued to Yu wherein disclosed is a frame for mounting on a vehicle seat back that provides for article arrangement via hook-like hangers and bags. Although this device may be suitable for stowing small articles, it would not meet the storage requirements for garments.

Yet another example can be seen in U.S. Pat. No. 4,201,415 issued to Suchanek wherein disclosed is a long distance truck tractor with living quarters. Suchanek discloses a truck tractor with two interior levels including driving and navigation equipment and living quarters with sleeping compartments. A stairway interconnects the two interior levels. Although Suchanek has attempted to improve the efficiency and comfort of long-distance truck drivers, he has failed to address storage space requirements in the increased living space, which will in turn result in a cluttered, unorganized area. The present invention provides the truck driver with an organized system within a confined space.

Yet another example can be seen in U.S. Pat. No. 4,108,487 issued to Spohn wherein disclosed are sleeper storage bins for use in the sleeper of a conventional tractor cab and cab over tractor cab. The sleeper storage bins as disclosed by Spohn may provide additional personal article storage space to a driver during long hauls, however, the storage bins are not easily accessible and would require waking of a sleeping driver should a second driver need accessibility to the stowed articles.

Though these devices may have proven to be successful in their scope of use, they address devices which are limited in their use. What is needed is a removeably secured modular cabinet and hanging system that will provide adequate storage and hanging space, as well as organization within the tight confinements of a sleeper cab of a tractor trailer, or a boat or a camper, or the like. Such a device should be efficient and substantially traditional in appearance so as to provide for a final product that is simple in design and structure and which will prove successful in achieving the desired results.

Hence, it is seen that none of these previous inventions provide the benefits intended with the present invention, such as providing a removeably secured modular cabinet and hanging system. Additionally, prior techniques do not suggest the present inventive combination of component elements as disclosed and claimed herein. The present invention achieves its intended purposes, objectives and advantages over the prior art devices through a new, useful and unobvious combination of component elements, which is simple to use, with the utilization of a minimum number of functioning parts, at a reasonable cost to manufacture, assemble, test and by employing only readily available material.

### SUMMARY OF THE INVENTION

The present invention provides for a removeably secured modular cabinet storage and hanging system that is adapted for installation within the cab or sleeping compartment of a vehicle, and will adequately maintain items in an organized storage system, as well as on a hanging rod for the storage of garments and the like by way of hangers in a fixed and wrinkle free environment. The modular cabinet storage and hanging system of the present invention is designed and configured so as to be quickly and easily removeably secured within the cab or sleeping compartment of a vehicle. Installation of the modular cabinet storage and hanging system is such that the system can be installed and removed within the vehicle without any necessary modification to the interior thereof.

A modular cabinet for use in a vehicle having a fold-down bed is disclosed herein. The cabinet includes a frame having a pair of brackets, wherein a first end of each of the brackets is adapted for clasping an upper edge of the fold-down bed, when in its folded-up position. A second end of each of the brackets is adapted for clasping the lower edge of the fold-down bed. The cabinet also includes a pair of securing straps for wrapping around a side of the fold-down bed opposite from the cabinet frame and each including two ends thereof for coupling to the two ends of each of the brackets. A pair of cam buckles are also included for tightening each of the securing straps around the fold-down bed, thereby securing the cabinet frame to the fold-down bed. The cabinet further includes shelves for storage and netting or curtains to cover the openings and secure the contents thereof. A garment hanging rod may also be integrated with the cabinet or installed separately on the fold-down bed or adjacent cabinets.

The modular cabinet and hanging system of the present invention is comprised of one or more hanging bars, as well as a hanging cabinet, all secured directly to the top fold-up bunk. The hanging system of the present invention is designed to maintain items in an organized storage manner, such as on a hanger rod for the storage of garments and the like by way of hangers in a fixed and wrinkle free environment. The modular cabinet is comprised of a plurality of openings extending horizontally down the cabinet and secured at the front openings with curtain, netting or the like. The modular cabinet provides for quick and easy access to articles stowed therein, as well as a safe and secure storage manner.

Accordingly, it is the object of the present invention to provide for a removeably secured modular cabinet and hanging system that will overcome the drawbacks, disadvantages, and shortcomings of prior article storage devices and methods thereof.

It is yet another object of the present invention to provide a removeably secured modular cabinet and hanging system which will adequately and efficiently maintain articles and garments in an efficient, organized and easily accessible manner. The final product is an aesthetically pleasing modular cabinet and hanging system.

Still another object of the present invention is to provide for a removeably secured modular cabinet and hanging system which is versatile and which will enable a user the option of hanging or storing articles and garments.

Yet another object of the present invention is to provide for a modular cabinet and hanging system which can be quickly and easily installed and removed. Further, this invention will provide for a modular cabinet and hanging system that will not be permanently secured to the surface maintaining the modular cabinet and hanging system. Accordingly, the device is non-obtrusive which will enable easy removal and replacement of the stored items, as well as offer accessibility and cleaning of the space defined by the modular cabinet and hanging system.

Still a further object of the present invention, to be specifically enumerated herein, is to provide a modular cabinet and hanging system in accordance with the preceding objects and which will conform to conventional forms of manufacture, be of simple construction and easy to use so as to provide a device that would be economically feasible, long lasting and relatively trouble free in operation.

Although there have been inventions related to article storage devices, none of the inventions have become sufficiently compact, low cost, functional and reliable enough to become commonly used. The present invention meets the requirements of functionality, simplified design, compact size, low initial cost, low operating cost, ease of installation and maintainability, and minimal amount of training to successfully employ the invention.

The foregoing has outlined some of the more pertinent objects of the invention. These objects should be construed to be merely illustrative of some of the more prominent features and applications of the intended invention. Many other beneficial results can be obtained by applying the disclosed invention in a different manner or modifying the invention within the scope of the disclosure. Accordingly, a fuller understanding of the invention may be had by referring to the detailed description of the preferred embodiments in addition to the scope of the invention taken in conjunction with the accompanying drawings.

### BRIEF DESCRIPTION OF THE DRAWINGS

FIG. 1 is a perspective view of the interior of a cab or sleeping compartment of a cabover/conventional tractor trailor truck.

FIG. 2 is a perspective view of the removeably secured modular cabinet and hanging system of the present invention as installed within the cab or sleeping compartment of a cabover/conventional tractor trailor truck.

FIG. 3 is a side view of the removeably secured modular cabinet and hanging system of the present invention.

FIG. 4 is a front elevation view of the modular cabinet of the present invention.

FIG. 5 is a side view of the attaching means of the modular cabinet of the present invention to the top fold-up bunk.

Similar reference numerals refer to similar parts throughout the views of the drawings.

### PREFERRED EMBODIMENT OF THE PRESENT INVENTION

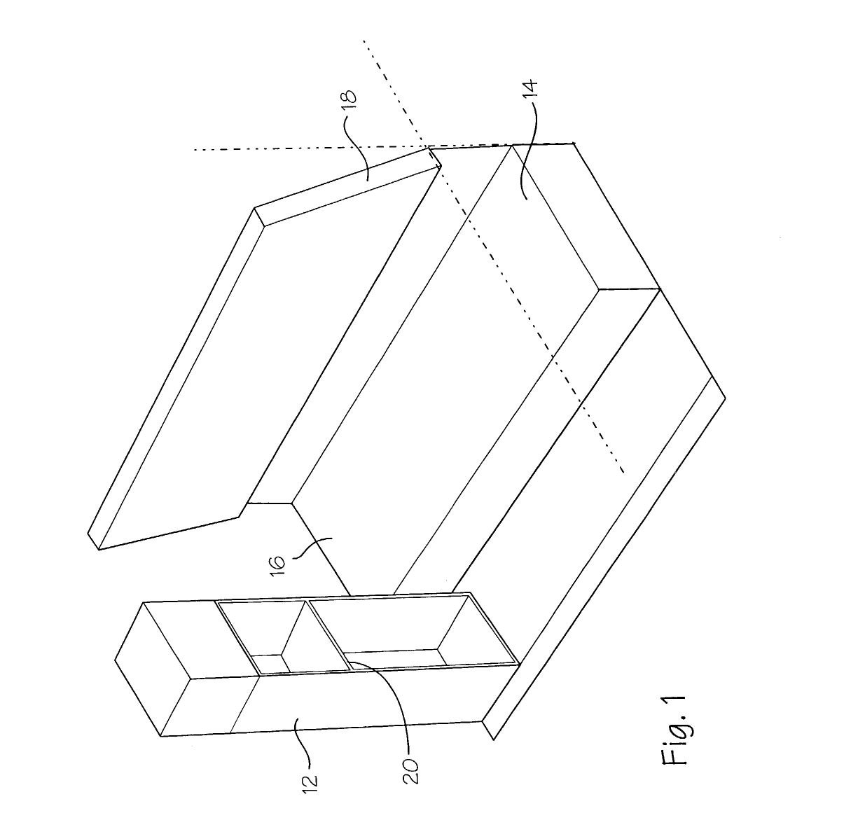

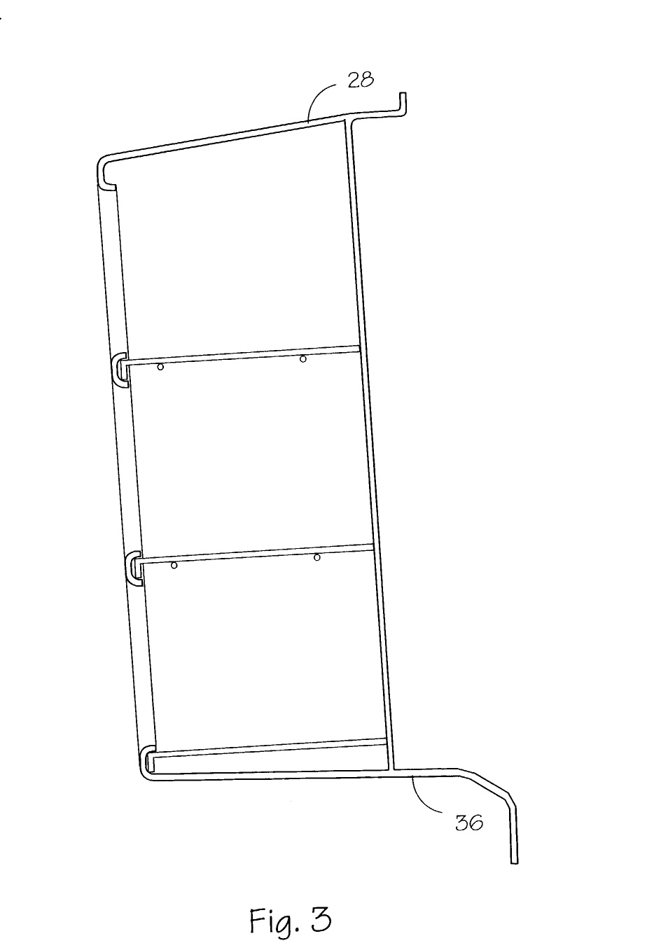

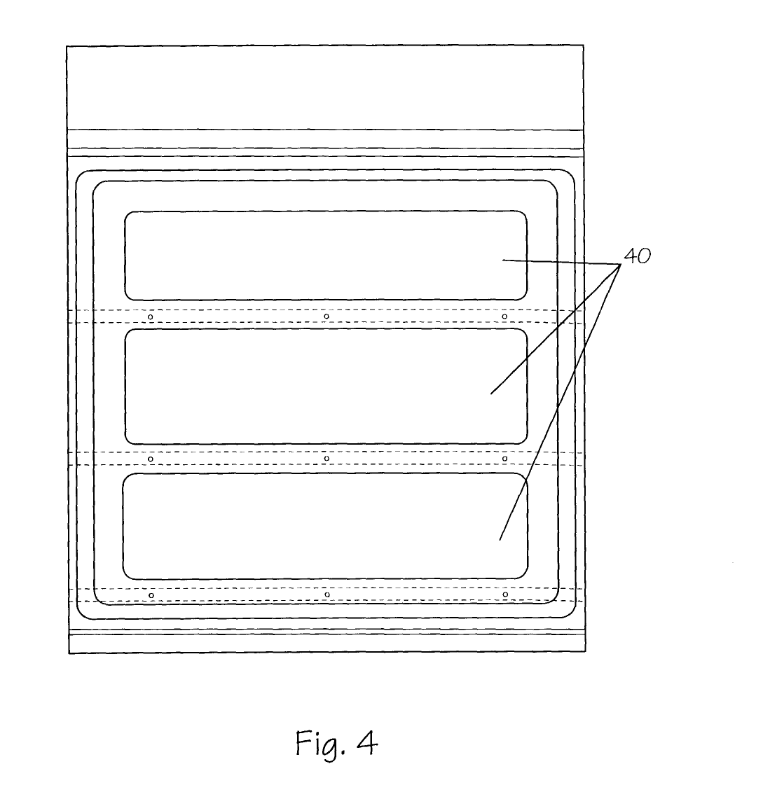

With reference to FIGS. 1-5, the present invention comprises a removeably secured modular cabinet and hanging system 10 that is adapted to be removeably secured within the interior of a vehicle. The modular cabinet and hanging system 10 of the present invention is designed and configured to be removeably secured in the cab or sleeping compartment of a vehicle without making any necessary modifications within the interior of the cab or sleeping compartment. The removeably secured modular cabinet and hanging system 10 of the present invention provides for adequate maintenance of articles in an efficient, organized storage system, thereby allowing for quick and easy access of stowed articles.

As shown in FIG. 1, and by way of example only, the cab or sleeping compartment of a cabover/conventional tractor trailer, prior to installation of the removeably secured modular cabinet and hanging system 10, is comprised of a factory installed cabinet 12, which is installed directly beside the top end 16 of the lower bunk 14, a lower bunk 14 and a fold-up upper bunk 18. The factory-installed cabinet 12 provides for a tall cabinet with one shelf 20 secured directly in the middle of the cabinet. It is seen that there is inadequate storage means, as well as no device to secure articles stowed within the cabinet 12.

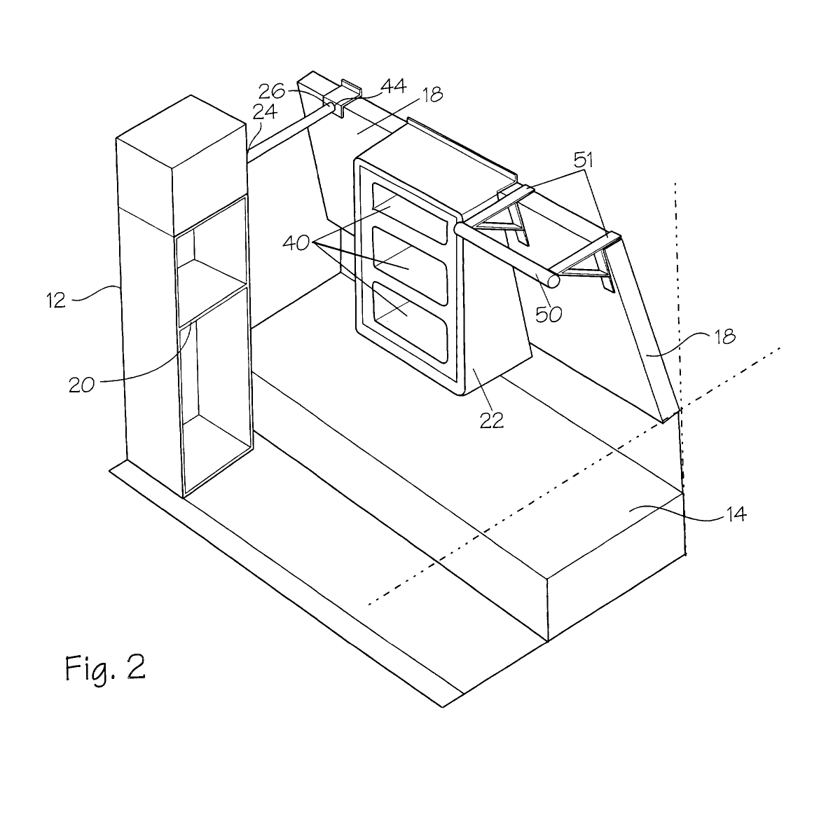

The present invention has been successfully employed within the interior of a cabover/conventional tractor trailer. As shown in FIG. 2, the removeably secured modular cabinet and hanging system 10 of the present invention provides for an efficient system for storage and organization of a multitude of items with quick and easy accessibility for the user. To provide for such an efficient system, the removeably secured modular cabinet and hanging system 10 of the present invention provides for a cabinet frame 22. The cabinet frame 22 is comprised of a single unit, fabricated from any durable material such as aluminum, plastic or the like. The cabinet frame can come in a variety of lengths and designs so as to provide a device that can be customized according to the consumers needs and desires.

In the preferred embodiment, the cabinet frame 22 is comprised of three shelves 40. These shelves 40 may be attached to the cabinet frame 22 with conventional securing means such as nuts, bolts, Christmas trees or the like, or may be built in during the manufacturing process. In order to prevent the items stored within the shelves of the cabinet frame 22, from moving during the ride, the device of the present invention further comprises a securing means such as curtains (not shown), netting (not shown) or the like which easily attaches over the apertures of the cabinet frame 22. The curtain, netting or the like is attached to the cabinet frame 22 by means of an extruding brace 26 or the like which will include an attaching means for hooking, snapping, Velcro or the like the material to the cabinet frame 22.

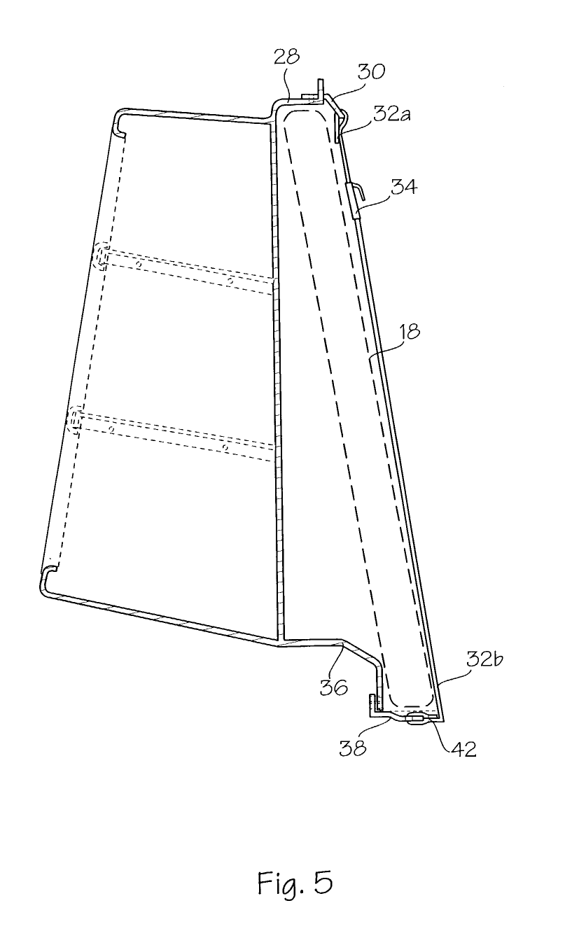

The cabinet frame 22 is secured to the under surface of the upper bunk 18. In order to secure the cabinet frame 22 of the present invention to the under surface of the upper bunk 18, the top portion of the cabinet frame 22 includes an “L” shaped metal or plastic (or the like) piece 28 which slides directly over the top of the folded-up upper bunk 18. Connected by conventional means at the base of the “L” shaped piece 28 is a bracket 30, as illustrated in FIG. 5. Secured by conventional means to the distal end 32 of the bracket 30 is a strap 32a. The strap 32a is pulled tightly behind the folded-up upper bunk, connecting on the opposite end to a cam buckle 34. The cam buckle 34 is attached to the top of strap 32b, which is secured at the base of the cabinet frame 22 to a bracket 42. The base of the cabinet frame 22 includes a brace 36 which fits securely under the mattress of the folded-up upper bunk 18 at the front portion. Attached to the bottom of the brace 36 is a bracket 38 which provides an attaching means for the strap 32b.

In an alternative embodiment, the cabinet frame of the present invention may be secured by means of Velcro, or any other attaching means.

In the preferred embodiment of the present invention, a hanging bar will be secured directly to the factory installed cabinet 12 by a removeably secured means at the proximal end 24 and to the fold-up upper bunk 18 by a removeably secured means at the distal end 26. The ends 24 and 26 are designed and configured to allow for the hanging bar to be quickly and easily removeably secured within the cab of the truck without making any permanent modifications within the interior of the truck. The removeably secured means at the distal end is comprised of a bracket 44, which slides directly over the mattress of the folded-up upper bunk 18. At the proximal end, the securing means may be comprised of any conventional attaching or securing means including but not limited to a hanging strap from the top of the conventional storage unit with a cup-like holder to secure the proximal end of the hanging bar.

In an alternative embodiment, the device of the present invention further may include an additional hanging bar 50, which secures directly to the folded-up upper bunk 18 by means of a hanger assembly 51 disposed on each end of the hanging bar 50.

Although the invention has been described with reference to a specific embodiment, this description is not meant to be construed in a limiting sense. Various modifications of the disclosed embodiment as well as alternative embodiments of the invention will become apparent to one skilled in the art upon reference to the description of the invention. It is therefore contemplated that the appended claims will cover any such modifications of embodiments that fall within the true scope of the invention.

We claim:

1. A modular cabinet for use in a vehicle having a fold-down bed, said cabinet comprising:
a. a cabinet frame including a bracket having two ends thereof, wherein a first end of said bracket is adapted for clasping an upper edge of said fold-down bed, when in its folded-up position, and a second end of said bracket is adapted for clasping the lower edge of said fold-down bed;
b. a securing strap for wrapping around the side opposite of said fold-down bed from said cabinet frame and including two ends thereof for coupling to the two ends of said bracket; and,
c. a cam buckle for tightening said securing strap around said fold-down bed, thereby securing said cabinet frame to said fold-down bed.

2. The modular cabinet as in claim 1 further including at least two brackets for securing said cabinet to said fold-up bed.

3. The modular cabinet as in claim 1 further including shelves for stowage.

4. The modular cabinet as in claim 3 further including netting disposed over openings for said shelves for securing items stowed in said cabinet.

5. The modular cabinet as in claim 3 further including curtains disposed over openings for said shelves for securing items stowed in said cabinet.

6. The modular cabinet as in claim 1 further including a garment hanging rod secured longitudinally to a front edge of said cabinet.

7. The modular cabinet as in claim 1 further including rubber insulation disposed on a side of said cabinet adjacent to said fold-up bed for preventing damage.

8. A modular cabinet for use in a sleeping compartment of a tractor cab, which compartment includes a fold-down bed, said cabinet comprising:
a. a cabinet frame including a pair of brackets each having two ends thereof, wherein a first end of each of said brackets is adapted for clasping an upper edge of said fold-down bed, when in its folded-up position, and a second end of each of said brackets is adapted for clasping the lower edge of said fold-down bed;
b. a pair of securing straps for wrapping around the side opposite of said fold-down bed from said cabinet frame and each including two ends thereof for coupling to the two ends of each of said brackets; and,
c. a pair of cam buckles for tightening each of said securing straps around said fold-down bed, thereby securing said cabinet frame to said fold-down bed.

9. The modular cabinet as in claim 8 further including shelves for stowage.

10. The modular cabinet as in claim 9 further including netting disposed over openings for said shelves for securing items stowed in said cabinet.

11. The modular cabinet as in claim 9 further including curtains disposed over openings for said shelves for securing items stowed in said cabinet.

12. The modular cabinet as in claim 8 further including a garment hanging rod secured longitudinally to a front edge of said cabinet.

13. The modular cabinet as in claim 8 further including rubber insulation disposed on a side of said cabinet adjacent to said fold-up bed for preventing damage.

14. A garment hanging rack for use in a vehicle having a fold-down bed, said rack comprising:
a. a frame including a pair of brackets each having two ends thereof, wherein a first end of each of said brackets is adapted for clasping an end of said handing rack and a second end for clasping an upper edge of said fold-down bed, when in its folded-up position;
b. the first end of each of said brackets including an angular extension; and,
c. the second end of each of said brackets including an extended member disposed parallel with the surface of said fold-down bed for engaging the surface thereof, and said angular extension around said extended member being joined for providing support for said rack.
